(19) United States
(12) Patent Application Publication
(10) Pub. No.: US 2014/0116181 A1
(43) Pub. Date: May 1, 2014

(54) CLIMATE CONTROL SYSTEM AND METHOD

(71) Applicant: HONDA MOTOR CO., LTD., Tokyo (JP)

(72) Inventor: Hajime Yamada, Ranchos Palos Verdes, CA (US)

(73) Assignee: HONDA MOTOR CO., LTD., Tokyo (JP)

(21) Appl. No.: 13/660,785

(22) Filed: Oct. 25, 2012

Related U.S. Application Data
(63) Continuation-in-part of application No. 13/644,564, now abandoned.

(51) Int. Cl. B60H 1/00

(52) U.S. Cl. CPC B60H 1/0065
USPC 74/480 R

(57) ABSTRACT

A climate control system and method for a vehicle includes a first rotary control for adjusting a first temperature setting, a second rotary control for adjusting a second temperature setting, and a master rotary control for adjusting both the first and second temperature settings. The first temperature setting is adjusted when the first rotary control knob is rotated independent of the second temperature setting. The second temperature setting is adjusted when the second rotary control knob is rotated independent of the first temperature setting. The first temperature setting and the second temperature setting are together adjusted when a master rotary control knob is rotated.

This application is a continuation-in-part of U.S. application Ser. No. 13/644,564 filed on Oct. 4, 2012, which is expressly incorporated herein by reference.

### BACKGROUND

As vehicle technologies have advanced, increased functionality has been applied to the various systems within modern vehicles. For example, increased functionality has been applied to various sub-systems within the vehicle, including climate control systems, audio systems, driving control systems, etc. With the increased functionality added to vehicles, it is often difficult to provide user-friendly controls for such systems. For example, it is difficult to provide controls that enable a driver to maintain a minimum amount of time with his or her eyes off the road and/or to provide ease of use for the driver or passengers within a vehicle.

An example function is the provision of dual climate control in connection with the climate control system of a vehicle. A wide array of controls has heretofore been proposed for operating the dual climate functionality of such an advanced climate control system. However, most of the known control systems fail to provide one or more of the following: ease of use for the driver and/or passengers, easy control of the complete functionality of a dual climate control system, usage that requires a minimum amount of driver attention, etc.

### SUMMARY

According to one aspect, a climate control system for a vehicle includes a first rotary control for adjusting a first temperature setting associated with a first zone of the vehicle and a second rotary control for adjusting a second temperature setting associated with a second zone of the vehicle. The climate control system further includes a master rotary control for adjusting both the first and second temperature settings and a controller operatively connected to each of the first rotary control, the second rotary control, and the master rotary control. The controller is configured to simultaneously adjust both the first and second temperature settings when the master rotary control is rotated, and is further configured to independently adjust the first temperature setting when the first rotary control is rotated and independently adjust the second temperature setting when the second rotary control is rotated.

According to another aspect, a vehicle climate control system includes a first control knob rotatable for adjusting a first temperature setting for a first zone of a vehicle, a second control knob rotatable for adjusting a second temperature setting for a second zone of the vehicle, and a master control knob rotatable for adjusting both the first and second temperature settings to a common temperature setting for both the first and second zones of the vehicle. The vehicle climate control system further includes a controller operatively connected to the first control knob, the second control knob, and the master control knob for receiving input therefrom. The controller enables adjustment of the first temperature setting and the second temperature setting independent from another when the first control knob or the second control knob is rotated, otherwise the controller enables adjustment of the common temperature setting when the master control knob is rotated.

According to a further aspect, a climate control method for a vehicle is provided. In the method according to this aspect, a first temperature setting associated with a first zone of the vehicle is adjusted when a first rotary control knob is rotated independent of a second temperature setting associated with a second zone of the vehicle. The second temperature setting is adjusted when a second rotary control knob is rotated independent of the first temperature setting. The first temperature setting and the second temperature setting are together adjusted when a master rotary control knob is rotated.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a partial perspective view of a dashboard portion of a vehicle having a vehicle climate control system including a first control knob, a second control knob, and a master control knob disposed between the first and second control knobs in accordance with one or more aspects of the present disclosure;

FIG. 2 is a schematic view of the vehicle climate control system of FIG. 1 in accordance with one or more aspects of the present disclosure;

FIG. 3 is a schematic operational view of the climate control system of FIG. 1 showing a display above the master control knob brightly illuminated and the displays above the first and second control knobs dimmed in accordance with one or more aspects of the present disclosure;

FIG. 4 is another schematic operational view of the climate control system of FIG. 1, similar to FIG. 3, but showing the displays above the first and second control knobs brightly illuminated and the display above the master control knob dimmed in accordance with one or more aspects of the present disclosure; and

FIG. 5 is a process flow diagram showing a climate control method for a vehicle in accordance with one or more aspects of the present disclosure.

### DETAILED DESCRIPTION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

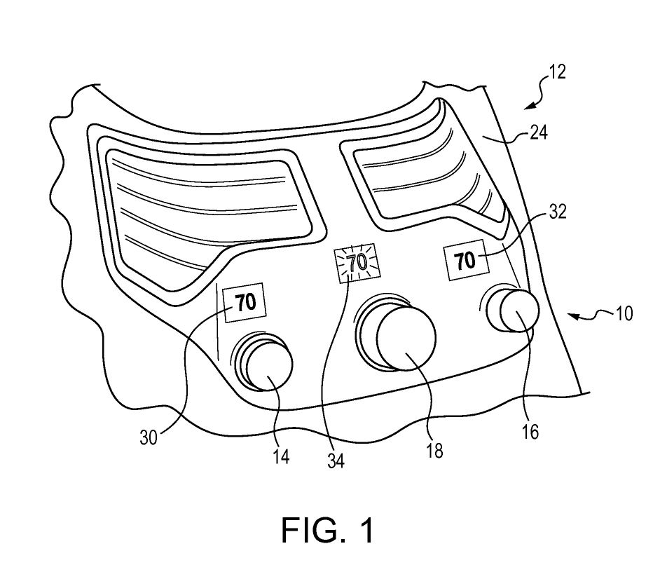

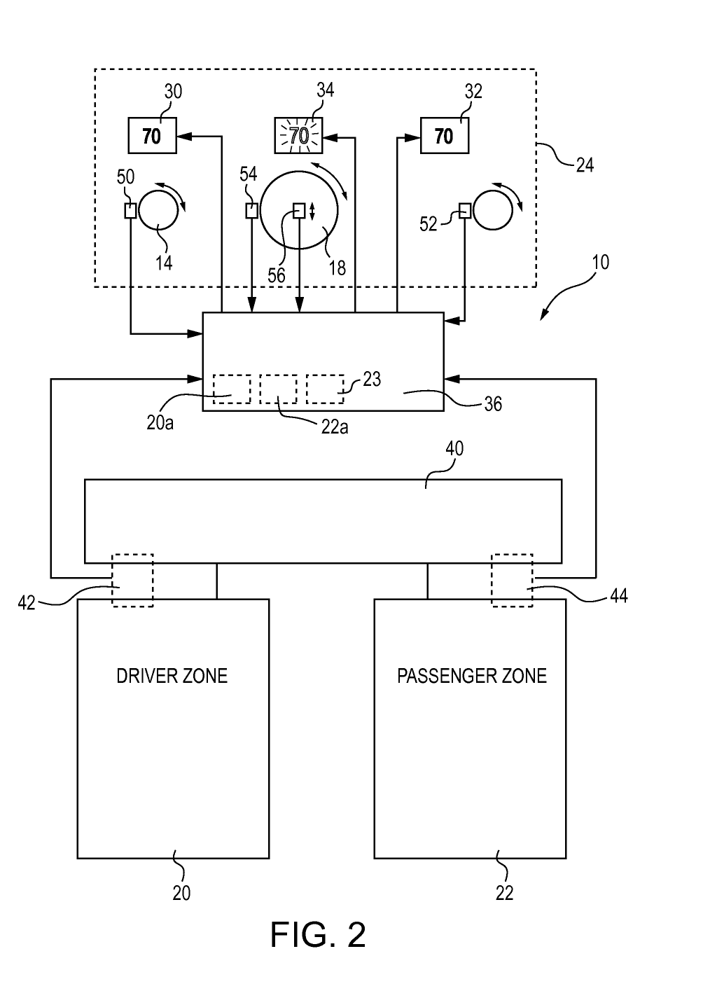

FIGS. 1 and 2 illustrate a vehicle climate control system 10 for a vehicle 12 including a first rotary control 14, a second rotary control 16, and a third or master rotary control knob 18. As shown, the first rotary control 14 can be a first control knob rotatable for adjusting a first temperature setting 20a for a first zone 20 of the vehicle 12 and the second rotary control 16 can be a second control knob rotatable for adjusting a second temperature setting 22a for a second zone 22 of the vehicle 12. The master rotary control knob 18 can likewise be a master control knob that is rotatable, but the master rotary control knob 18 is rotatable for adjusting both the first and second temperature settings 20a, 22a to a common temperature setting 23 for both the first and second zones 20, 22 of the vehicle 12. By providing three rotary controls 14, 16, and 18 additional functionalities can be implemented and associated with those controls, for example, radio control features.

As shown, the master rotary control knob 18 can be disposed between the first and second control knobs 14, 16 on a vertically oriented dashboard portion 24 within the vehicle 12, though this is not required. Thus, in the illustrated embodiment, the master rotary control knob 18 is positioned laterally between the first and second rotary control knobs 14, 16 (i.e., the first and second rotary control knobs 14, 16 flank the master rotary control knob 18). In one embodiment, the first temperature setting 20a corresponds to a temperature of air being forced to the first zone 20 by the climate control system 10 and the second temperature setting 22a corresponds to a temperature of air being forced to the second zone 22 by the climate control system 10. Alternatively, the temperature control settings 20a, 22a can correspond to desired temperatures within the zones 20, 22, respectively (i.e., temperatures toward which the climate control system 10 will attempt to condition air within the zones 20, 22).

The climate control system 10 can additionally include a first display associated with the first rotary control knob 14 for displaying the first temperature setting 20a or a visual indication thereof when the first rotary control knob 14 is rotated, a second display 32 associated with the second rotary control knob 16 for displaying the second temperature setting 22a or a visual indication thereof when the second rotary control knob 16 is rotated, and a third or master display 34 associated with the master rotary control knob 18 for displaying the common temperature setting 23, or a visual indication thereof, to which the first and second temperature settings 20a, 22a are made equal when the master rotary control knob 18 is rotated. In the illustrated embodiment, as shown, the first display 30 is disposed directly above the first rotary control knob 14, the second display 32 is disposed directly above the second rotary control knob 16, and the third display 34 is disposed directly above the master rotary control knob 18, though other arrangements could be employed (e.g., a single display could be provided with three display portions corresponding to the controls 14, 16, 18). Additionally, in the illustrated embodiment, the displays 30, 32, 34 are spaced apart from one another, particularly the displays 30, 32, 34 are spaced apart laterally in a width direction of the vehicle 12. The displays 30, 32, 34 can be reproduced on a head unit having a single screen.

Further, and as particularly shown schematically in FIG. 2, the climate control system 10 can include a controller 36 operatively connected to each of the first rotary control knob 14, the second rotary control knob 16, and the master rotary control knob 18 for receiving input therefrom. The first temperature setting 20a, the second temperature setting 22a and the common temperature setting 23 can be values stored in a memory of the controller 36. The controller 36 can be configured to simultaneously adjust both the first and second temperature settings 20a, 22a when the master rotary control knob 18 is rotated, and can be further configured to independently adjust the first temperature setting 20a when the first rotary control knob 14 is rotated and independently adjust the second temperature setting 22a when the second rotary control knob 16 is rotated. In one embodiment, the controller 36 can be configured to simultaneously adjust both the first and second temperature settings 20a, 22a to the common temperature setting 23 (i.e., not just simultaneously adjust the first and second temperature settings 20a, 22a) when the master rotary control knob 18 is rotated. The controller 36 enables adjustment of the first temperature setting 20a and the second temperature setting 22a independent from one another when the first control knob 14 or the second control knob 16 is rotated, otherwise the controller 36 enables adjustment of only the common temperature setting 23 when the master control knob 18 is rotated (and the first and second temperature settings 20a, 22a are made equal to the common temperature setting 23).

As illustrated schematically in FIG. 2, the climate control system 10 can further include various HVAC components 40 that enable climate control within the first and second zones 20, 22 of the vehicle 12. The HVAC components 40 can include a heater core, a condenser, various air mixing doors, air passageways, ducts, vents, ports, etc. The controller 36 can be operatively connected to the HVAC components and can operate the HVAC components 40 for purposes of delivering conditioned air to the zones 20, 22 in accordance with the first and second temperature settings 20a, 22a. In one embodiment, the controller 36 operates the HVAC components 40 so as to deliver conditioned air to the zones 20, 22, respectively, in accord with the first temperature setting and the second temperature setting 20a, 22a, whether independently set by the controls knobs 14 and 16 or set to equal the common temperature setting 23 via the master control knob 18.

In operation, a driver or passenger of the vehicle 12 can operate (e.g., rotate) the control knobs 14, 16, 18 to adjust the first and second temperature settings 20a, 22a, which can be stored in a memory of the controller 36. In particular, and such as when the first zone 20 is a driver's side zone and a second zone 22 is a passenger side zone, the passenger and/or driver can use the individualized temperature control knobs 14, 16 flanking the master control knob 18 for adjusting and/or setting the temperature of separate airflow to the respective zones 20, 22 in an individual mode of the climate control system 10. Optionally, the system 10 can include various feedback devices 42, 44 used in association with the zones 20, 22 for purposes of providing temperature feedback to the controller 36. The feedback devices 42, 44 can be part of the HVAC components 40, in whole or part, or can be independently provided in association with the zones 20, 22. In one example, the feedback devices 42, 44 are temperature sensors that provide temperature measurements of the conditioned air provided to the zones 20, 22 and relay these measurements back to the controller 36. Alternatively, the feedback devices 42, 44 can be temperature sensors that provide temperature measurements within the zones 20, 22 and these measurements of ambient temperatures within the respective zones 20, 22 are relayed back to the controller 36.

As shown schematically, the first and second control knobs 14, 16 can be operatively connected to the controller 36. In particular, encoders 50, 52 can be provided in association with the control knobs 14, 16 for providing the rotational position of the control knobs 14, 16 back to the controller 36. The master control knob 18 can likewise be operatively connected to the controller 36. In particular, an encoder 54 can be provided in association with the master control knob 18 for providing the rotational position of the master control knob 18 back to the controller 36. In addition, the master rotary control knob 18 can be operable by press actuation (i.e., the master control knob 18 includes push actuation) for powering on the climate control system 10. Accordingly, a push-type actuator 56 can be provided in association with the rotary control knob 18 for relaying push actuation of the control knob 18 back to the controller 36. In one embodiment, the master rotary control knob 18 via the push-type actuator 56 and the configuration of the controller 36 operates to toggle the climate control system 10 on and off.

As schematically shown, the displays 30, 32, 34 can also each be operatively connected to the controller 36. The controller 36 can be operatively connected to each of the displays 30, 32, 34 for controlling the displays. In the illustrated embodiment, the displays 30, 32, 34 can display a numeric temperature value associated with the first and second temperature settings, though other displays are contemplated (e.g., a visual indication of temperature that is not numerically based, a visual indication that provides a relative position within a range, etc.). For example, the displays 30, 32, 34 can display a numeric temperature value (e.g., 70 degrees Fahrenheit) that is or correlates to one of the temperature settings 20a, 22a. Celsius temperature readings can also be provided.

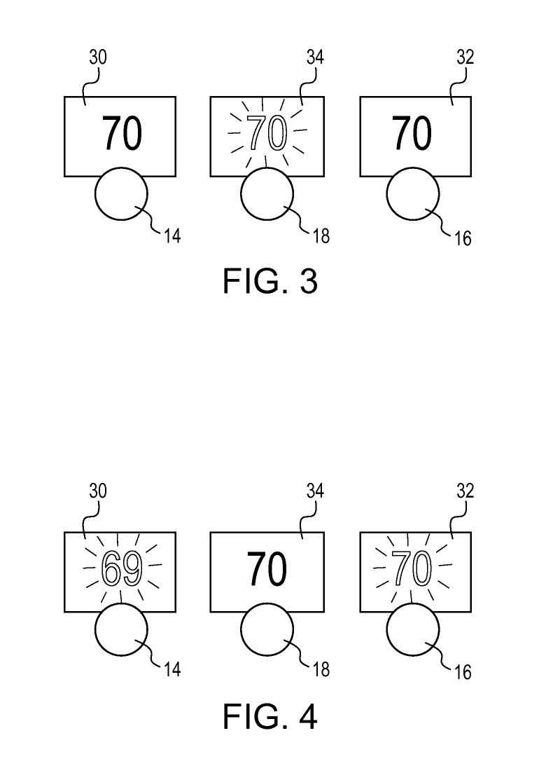

With a specific reference to FIG. 3, the climate control system 10 is shown in a master control state or mode with the common temperature setting 23 or a numeric representation thereof (e.g., 70 degrees Fahrenheit in the illustrated embodiment) brightly illuminated by the third display 34 when the master control knob 18 is rotated. Thus, in one example, conditioned air can be provided to the driver and passenger zones 20, 22 at the temperature indicated on the display 34 above the master rotary control knob 18 when the display 34 is brightly illuminated. The master rotary control knob 18 also allows adjustment via rotation thereof at this time (i.e., when the display 34 is illuminated).

In contrast and with additional reference to FIG. 4, the climate control system 10 is shown in the individual control state or mode with the first and second temperature settings 20a, 22a (or visual indications thereof) brightly illuminated, respectively, by the first display 30 and the second display 32 when the first or second rotary control knobs 14, 16 are rotated. Thus, the first display 30 brightly illuminates the first temperature setting 20a or a numeric representation thereof when the first or second control knobs 14, 16 are rotated. Likewise, the second display 32 brightly illuminates the second temperature setting 22a or a numeric representation thereof when the first or second control knobs 14, 16 are rotated. Similarly, the third display 34 brightly illuminates the common temperature setting 23 (i.e., the common temperature setting to which both the first and second temperature settings are set to) or a numeric representation thereof when the master control knob 18 is rotated. Thus, when the zones 20, 22 are passenger and driver side zones, the display 34 above the master control knob 18 goes dim and the displays 30, 32 above the control knobs 14, 16 become brightly illuminated when either the passenger or driver rotates one or both of the controls 30, 32. Also, adjustment is permitted of the first and second temperature settings 20a, 22a via the first and second control knobs 14, 16 at this time (i.e., when the displays 30, 32 are illuminated.

Additionally, and as shown in the illustrated embodiment, the third display 34 can be dimmed when the first and second displays 30, 32 are brightly illuminating the first and second temperature settings 20a, 22a or numeric representations thereof. Similarly, the first and second displays 30, 32 are dimmed when the third display 34 is brightly illuminating the common temperature setting or a numeric representation thereof on the third display 34. More particularly, the first and second displays 30, 32 operate in a grayed-out mode when the common temperature setting 23 is brightly illuminated by the third display 34. Likewise, the third display 34 operates in a grayed-out mode when the first and second temperature settings are brightly illuminated by the first and second displays, 30, 32. Also, though not shown in the illustrated embodiment, the displays 30, 32, 34 associated with each of the rotary control knobs 14, 16, 18 operate in the grayed-out mode when the climate control system 10 is in an off mode.

As mentioned above, the climate control system 10 can be put into the off mode by toggling the master rotary control knob 18, particularly via push actuation thereof, and the climate control system 10 can be turned back on to an “on” mode by again toggling the master rotary control knob 18 via push actuation. In one embodiment, when the climate control system 10 is initially placed into the on state, the display 34 above the master rotary control knob 18 can always be brightly illuminated and the master control knob 18 can adjust the common temperature setting 23 for the zones 20, 22 until one of the knobs 14, 16 is rotated. Alternatively, the system 10 can be initially set to the state it was in when last turned off and a second depression of the master rotary control 18 can put the system into the master control state.

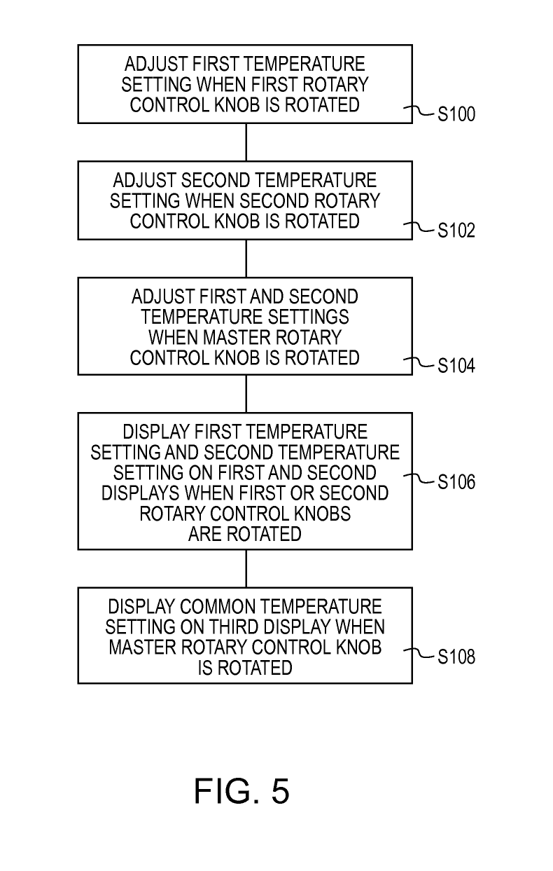

With reference now to FIG. 5, a climate control method for a vehicle will be described. In particular, the method of FIG. 5 will be described with the climate control system 10 illustrated in FIGS. 1-4, though it is to be appreciated that the climate control method could be used with other climate control systems. In the method illustrated in FIG. 5, at S100 the first temperature setting 20a associated with the first zone 20 of the vehicle 12 is adjusted when the first rotary control knob 14 is rotated independent of the second temperature setting 22a associated with the second zone 22 of the vehicle 12. The second temperature setting 22a is adjusted in S102 when the second rotary control knob 16 is rotated independent of the first temperature setting 20a. In S104, the first temperature setting 20a and the second temperature setting 22a are together adjusted when the master rotary control knob 18 is rotated. Adjusting the first and second temperature settings together in S104 when the master rotary control knob 18 is rotated can particularly include setting the first and second temperature settings 20a, 22a to the common temperature setting 23.

Additionally, at S106, the first temperature setting 20a is displayed on the first display 30 and the second temperature setting 22a is displayed on the second display 32 when one or both of the first or second rotary control knobs 14, 16 are rotated. In S108, the common temperature setting is displayed on the third display 34 when the master rotary control knob 18 is rotated or actuated (e.g., push actuation). Displaying the common temperature setting on the third display in S108 can additionally include dimming the first temperature setting 20a on the first display 30 and the second temperature setting 22a on the second display 32 when the master rotary control knob 18 is rotated or actuated. Similarly, displaying the first temperature setting 20a and the second temperature setting 22a on the first and second displays 30, 32 in S106 can include dimming the common temperature setting 23 on the third display 34 when one or both of the first or second rotary control knobs 14, 16 are rotated.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

1. A climate control system for a vehicle, comprising:
a first rotary control for adjusting a first temperature setting associated with a first zone of the vehicle;
a second rotary control for adjusting a second temperature setting associated with a second zone of the vehicle;
a master rotary control for adjusting both the first and second temperature settings; and
a controller operatively connected to each of the first rotary control, the second rotary control and the master rotary control, wherein the controller is configured to simultaneously adjust both the first and second temperature settings when the master rotary control is rotated, and configured to independently adjust the first temperature setting when the first rotary control is rotated and independently adjust the second temperature setting when the second rotary control is rotated.

2. The climate control system of claim 1 wherein the controller is configured to simultaneously adjust both the first and second temperature settings to a common temperature setting when the master rotary control is rotated.

3. The climate control system of claim 1 wherein the master rotary control is positioned laterally between the first and second rotary controls.

4. The climate control system of claim 1 including:
a first display associated with the first rotary control knob for displaying the first temperature setting when the first rotary control is rotated; and
a second display associated with the second rotary control knob for displaying the second temperature setting when the second rotary control is rotated,
wherein the first and second displays are operatively connected to the controller.

5. The climate control system of claim 4 including:
a third display associated with the master control for displaying a common temperature setting to which the first and second temperature settings are made equal when the master rotary control is rotated.

6. The climate control system of claim 5 wherein the first and second temperature settings are brightly illuminated, respectively, by the first display and the second display when the first or second rotary controls are rotated.

7. The climate control system of claim 6 wherein the common temperature setting is brightly illuminated by the third display when the master control is rotated.

8. The climate control system of claim 7 wherein the first and second displays operate in a grayed-out mode when the common temperature setting is brightly illuminated by the third display and the third display operates in a grayed-out mode when the first and second temperature settings are brightly illuminated by the first and second displays.

9. The climate control system of claim 1 wherein the first temperature setting corresponds to a temperature of air being forced to the first zone and the second temperature setting corresponds to a temperature of air being forced to the second zone.

10. The climate control system of claim 1 wherein the master rotary control is additionally operable by press actuation for powering on the climate control system.

11. The climate control system of claim 10 wherein displays associated with each of the rotary controls operate in a gray-out mode when the climate control system is in an off mode.

12. A vehicle climate control system, comprising:
a first control knob rotatable for adjusting a first temperature setting for a first zone of a vehicle;
a second control knob rotatable for adjusting a second temperature setting for a second zone of the vehicle;
a master control knob rotatable for adjusting both the first and second temperature settings to a common temperature setting for both the first and second zones of the vehicle; and
a controller operatively connected to the first control knob, the second control knob and the master control knob for receiving input therefrom, the controller enabling adjustment of the first temperature setting and the second temperature setting independent from one another when the first control knob or the second control knob is rotated, otherwise the controller enabling adjustment of the common temperature setting when the master control knob is rotated.

13. The vehicle climate control system of claim 12 including:
a first display disposed above the first control knob and operatively connected to the controller, the first display brightly illuminating the first temperature setting when the first or second control knobs are rotated; and
a second display disposed above the second control knob and operatively connected to the controller, the second display brightly illuminating the second temperature setting when the first or second control knobs are rotated.

14. The vehicle climate control system of claim 13 including:
a third display disposed above the master control knob and operatively connected to the controller, the third display brightly illuminating the common temperature setting when the master control knob is rotated, the third display dimmed when the first and second display are brightly illuminating the first and second temperature settings, and the first and second displays dimmed when the third display is brightly illuminating the common temperature setting.

15. The vehicle climate control system of claim 12 wherein the master control knob includes push actuation for powering on the vehicle climate control system.

16. The vehicle climate control system of claim 12 wherein the master control knob is disposed between the first and second control knobs on a vertically oriented dashboard portion.

17. A climate control method for a vehicle, comprising:
adjusting a first temperature setting associated with a first zone of the vehicle when a first rotary control knob is rotated independent of a second temperature setting associated with a second zone of the vehicle;
adjusting the second temperature setting when the second rotary control knob is rotated independent of the first temperature setting; and
adjusting the first temperature setting and the second temperature setting together when a master rotary control knob is rotated.

18. The climate control method of claim 17 wherein adjusting the first and second temperature settings together when the master rotary control knob is rotated includes setting the first and second temperature settings to a common temperature setting.

19. The climate control method of claim 18 including:
displaying the first temperature setting on a first display and the second temperature setting on a second display when one or both the first and second rotary control knobs are rotated; and
displaying the common temperature setting on a third display when the master rotary control knob is rotated or actuated.

20. The climate control method of claim 19 wherein displaying the first temperature setting on the first display and the second temperature setting on the second display includes dimming the common temperature setting on the third display, and wherein displaying the common temperature setting on the third display includes dimming the first temperature setting on the first display and the second temperature setting on the second display.
